(19) United States
(12) Patent Application Publication
(10) Pub. No.: US 2010/0153099 A1
(43) Pub. Date: Jun. 17, 2010

(54) SPEECH ENCODING APPARATUS AND SPEECH ENCODING METHOD

(75) Inventors: Michiyo Goto, Tokyo (JP); Koji Yoshida, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/088,318

(22) PCT Filed: Sep. 29, 2006
(86) PCT No.: PCT/JP2006/319435

§ 371 Date: Mar. 27, 2008

(30) Foreign Application Priority Data
Sep. 30, 2005 (JP) 2005-286531

(51) Int. Cl. G10L 19/00

(52) U.S. Cl. 704/219; 704/E19.001

(57) ABSTRACT

A speech coder and so forth for preventing deterioration of the quality of a reproduced speech signal while reducing the coding rate. In a speech signal modifying section (101) of the coder, a masking threshold calculating section (114) calculates a masking threshold M(f)) of the spectrum S(f) of an input speech signal, an ACB sound source model spectrum calculating section (117) calculates an adaptive codebook sound source model spectrum SACB(f), an input spectrum shape modifying section (112) refers to both values of the masking threshold M(f) and the adaptive code book sound source model spectrum S′ACB(f) having an LPC spectral envelope and carries out a preprocessing of the spectrum S(f) so that the shape of the spectrum S(f) is modified to match a CELP coding section (102) of the succeeding stage. The CELP coding section (102) carries out CELP coding of the preprocessed speech signal and outputs a coded parameter.

### TECHNICAL FIELD

The present invention relates to a speech encoding apparatus and speech encoding method employing the CELP (Code-Excited Linear Prediction) scheme.

### BACKGROUND ART

Encoding techniques for compressing speech signals or audio signals in low bit rates are important to utilize mobile communication system resources effectively. There are speech signal encoding schemes such as G726 and G729 standardized in ITU-T (International Telecommunication Union Telecommunication Standardization Sector). These schemes are targeted for narrowband signals (between 300 Hz and 3.4 kHz), and enables high quality speech signal encoding in bit rates of 8 to 32 kbits/s. On the other hand, as for wideband signal encoding schemes (between 50 Hz and 7 kHz), for example, there are G722 and G722.1 standardized in ITU-T and AMR-WB standardized in 3GPP (The 3rd Generation Partnership Project). These schemes enables high quality wideband signal encoding in bit rates of 6.6 to 64 kbits/s.

Further, schemes that enables high efficiency speech signal encoding in low bit rates include CELP encoding. The CELP encoding is a scheme of determining encoded parameters based on a human speech generating model such that the square error between input signals and generated output signals, which are obtained by filtering excitation signals represented by random numbers or pulse trains pass through a pitch filter associated with the degree of periodicity and a synthesis filter associated with the vocal tract characteristics, is minimized under weighting of auditory characteristics. Most of the recent standard speech encoding schemes are based on CELP encoding. For example, G.729 enables narrowband signal encoding in bit rates of 8 kbits/s, and AMW-WB enables wideband signal encoding in bit rates of 6.6 to 23.85 kbits/s.

As techniques of performing high quality encoding in low bit rates using CELP encoding, there is a technique of calculating auditory masking thresholds in advance and performing encoding with reference to the auditory masking threshold upon performing perceptual weighting (for example, see Patent Document 1). Auditory masking is a technique of utilizing, in the frequency domain, human auditory characteristic that a signal close to a certain signal is not heard (that is, “masked”). A spectrum with lower amplitude than the auditory masking thresholds is not sensed by human auditory sense, and, consequently, even if this spectrum is excluded from the encoding target, little auditory distortion is sensed by human. Therefore, it is possible to suppress degradation of sound quality partially and reduce coding bit rates.

Patent Document 1: Japanese Patent Application Laid-Open No. Hei 7-160295 (Abstract)

### DISCLOSURE OF INVENTION

### Problems to be Solved by the Invention

According to the above-described technique, although a perceptual weighting filter becomes accurate in the amplitude domain by taking into consideration the masking threshold, the accuracy of the filter does not change in the frequency domain because the order of the filter does not change. That is, with the above-described technique, there are problems including degrading quality of reproduced speech signals due to the insufficient accuracy of filter coefficients of the perceptual weighting filter.

It is therefore an object of the present invention to provide a speech encoding apparatus and speech encoding method that can reduce coding bit rates utilizing, for example, auditory masking technique, and still prevent quality degradation of reproduced speech signals.

### Means for Solving the Problem

The speech encoding apparatus of the present invention employs a configuration having: a encoding section that performs code excited linear prediction encoding for a speech signal; and a preprocessing section that is provided at a front stage of the encoding section and that performs preprocessing on the speech signal in a frequency domain such that the speech signal is more adaptive to the code excited linear prediction encoding.

Further, the preprocessing section employs a configuration having: a converting section that performs a frequency domain conversion of the speech signal to calculate a spectrum of the speech signal; a generating section that generates an adaptive codebook model spectrum based on the speech signal; a modifying section that compares the spectrum of the speech signal to the adaptive codebook model spectrum, modifies the spectrum of the speech signal such that the spectrum of the speech signal is similar to the adaptive codebook model spectrum, and acquires a modified spectrum; and an inverse converting section that performs an inverse frequency domain conversion of the modified spectrum back to a time domain signal.

### ADVANTAGEOUS EFFECT OF THE INVENTION

According to the present invention, it is possible to reduce coding bit rates and prevent reproduced speech signal quality degradation.

### BRIEF DESCRIPTION OF DRAWINGS

FIG. 1 is a block diagram showing main components of a speech encoding apparatus according to Embodiment 1;

FIG. 2 is a block diagram showing main components inside a CELP encoding section according to Embodiment 1;

FIG. 3 is a pattern diagram showing a relationship between an input speech spectrum and a masking spectrum;

FIG. 4 illustrates an example of a modified input speech spectrum;

FIG. 5 illustrates an example of a modified input speech spectrum;

FIG. 6 is a block diagram showing main components of a speech encoding apparatus according to Embodiment 2; and

FIG. 7 is a block diagram showing main components inside a CELP encoding section according to Embodiment 2.

### BEST MODE FOR CARRYING OUT THE INVENTION

Embodiments of the present invention will be explained below in detail with reference to the accompanying drawings.

### Embodiment 1

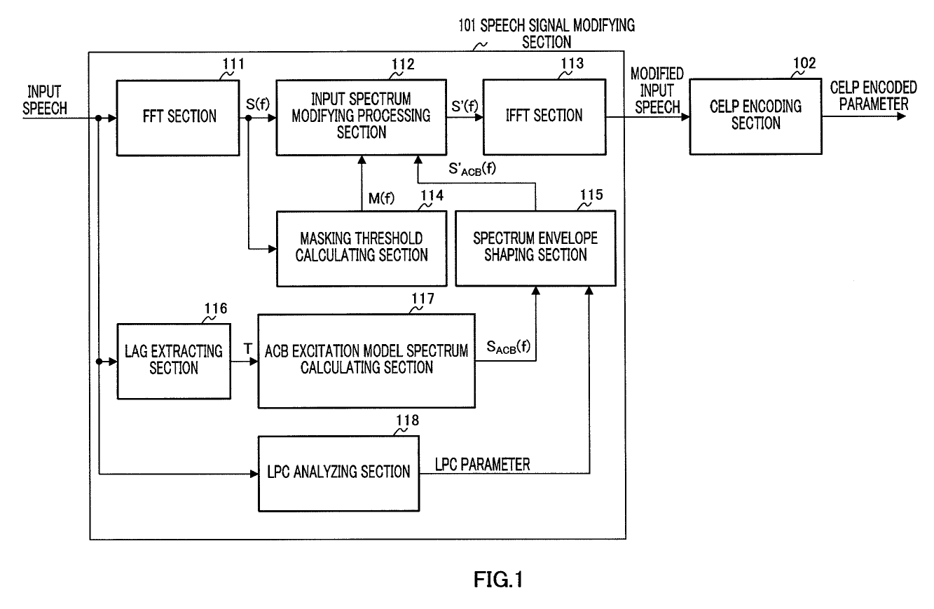

FIG. 1 is a block diagram showing the configuration of main components of the speech encoding apparatus according to Embodiment 1 of the present invention.

The speech encoding apparatus according to the present embodiment is mainly configured from speech signal modifying section 101 and CELP encoding section 102. Speech signal modifying section 101 performs the following preprocessing on input speech signals in the frequency domain, and CELP encoding section 102 performs CELP scheme encoding for signals after the preprocessing and outputs CELP encoded parameters.

First, speech signal modifying section 101 will be explained.

Speech signal modifying section 101 has FFT section 111, input spectrum modifying processing section 112, IFFT section 113, masking threshold calculating section 114, spectrum envelope shaping section 115, lag extracting section 116, ACB excitation model spectrum calculating section 117 and LPC analyzing section 118. The operations of each section will be explained below.

FFT section 111 converts input speech signals into frequency domain signals S(f) by performing a frequency domain transform (i.e., FFT which means fast Fourier transform) for the input speech signals in coding frame periods and outputs signal S(f) to input spectrum modifying processing section 112 and masking threshold calculating section 114.

Masking threshold calculating section 114 calculates masking threshold M(f) from the frequency domain signals outputted from FFT section 111, that is, from the spectrum of the input speech signals. The masking thresholds are calculated through processing of determining the sound pressure level with respect to each band after the frequency band is divided, determining the minimum audibility value, detecting the pure tone element and impure tone element of the input speech signal, selecting maskers to acquire useful maskers (the main apparatus for auditory masking), calculating masking thresholds of each useful maskers and the threshold of all maskers, and determining the minimum masking threshold of each divided band.

Lag extracting section 116 has an adaptive codebook (which may be abbreviated to “ACB” hereinafter), and extracts the adaptive codebook lag T by performing adaptive codebook search for the input speech signal (i.e., the speech signal before inputting to input spectrum modifying processing section 112) and outputs the adaptive codebook lag T to ACB excitation model spectrum calculating section 117. This adaptive codebook lag T is required to calculate the ACB excitation model spectrum. Further, a pitch period is calculated by performing open-loop pitch analysis for input speech signals, and this calculated pitch periods may be referred to as “T”.

ACB excitation model spectrum calculating section 117 calculates an ACB excitation model spectrum (harmonic structure spectrum) S_{ACB}(f) using the adaptive codebook lag T outputted from lag extracting section 116 and following equation 1, and outputs this calculated S_{ACB} to spectrum envelope shaping section 115.

(Equation 1)

1/(1−z^{-T}) [1]

LPC analyzing section 118 performs LPC analysis (linear prediction analysis) for input speech signals and outputs the acquired LPC parameters to spectrum envelope shaping section 115.

Spectrum envelope shaping section 115 performs an LPC spectrum envelope shaping to the ACB excitation model spectrum S_{ACB}(f) using the LPC parameter outputted from LPC analyzing section 118. This ACB excitation model spectrum S′_{ACB}(f) to which an LPC spectrum envelope shaping is performed, is outputted to input spectrum modifying processing section 112.

Input spectrum modifying processing section 112 performs predetermined modifying processing per frame on the spectrum of the input speech (i.e., input spectrum) outputted from FFT section 111, and outputs the modified spectrum S′(f) to IFFT section 113. In this modifying processing, the input spectrum is modified such that this input spectrum is adaptive to CELP encoding section 102 at a rear stage, and the modifying processing will later be described in detail with the drawings.

IFFT section 113 performs an inverse frequency domain transform, that is, an IFFT (Inverse Fast Fourier Transform), for the modified spectrum S′(f) outputted from input spectrum modifying processing section 112, and outputs acquired time domain signals (i.e., modified input speech) to CELP encoding section 102.

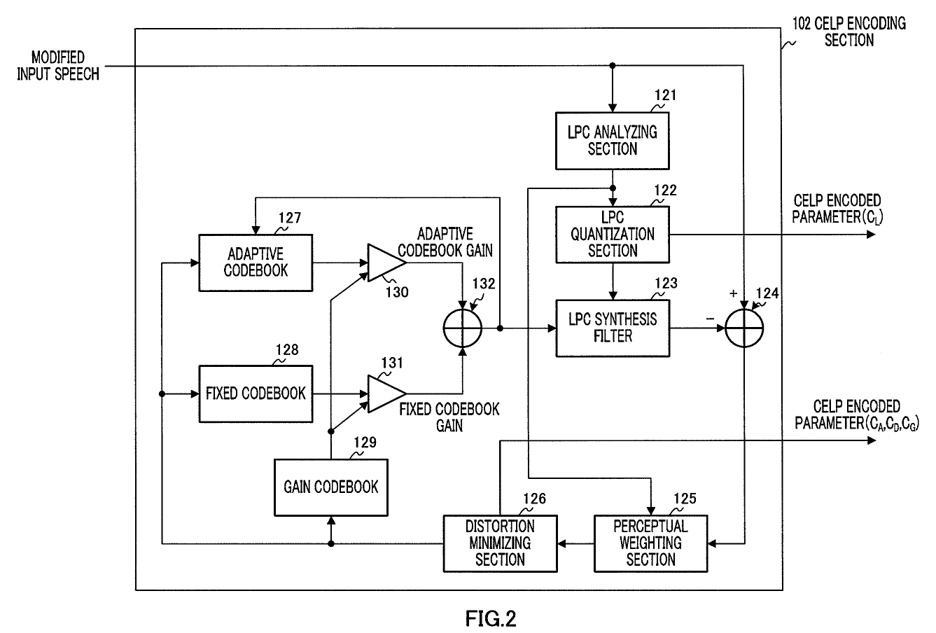

FIG. 2 is a block diagram showing main components inside CELP encoding section 102. The operations of each component of CELP encoding section 102 will be explained below.

LPC analyzing section 121 performs linear prediction analysis for the input signal of CELP encoding section 102 (i.e., modified input speech) and calculates LPC parameters. LPC quantization section 122 quantizes these LPC parameters and outputs the acquired quantized LPC parameters to LPC synthesis filter 123 and outputs index C_{L} showing these quantized LPC parameters.

On the other hand, adaptive codebook 127 generates an excitation vector for one subframe from stored past excitation signals according to the adaptive codebook lag commanded by distortion minimizing section 126. Fixed codebook 128 outputs the predetermined-formed, fixed codebook vector stored in advance, according to command from distortion minimizing section 126. Gain codebook 129 generates adaptive codebook gain and fixed codebook gain according to command from distortion minimizing section 126. Multiplexer 130 and multiplexer 131 multiply outputs of adaptive codebook 127 and fixed codebook 128 with adaptive codebook gain and fixed codebook gain, respectively. Adder 132 adds outputs of adaptive codebook 127 multiplied with the adaptive codebook gain and fixed codebook 128 multiplied with the fixed codebook gain, and outputs these to LPC synthesis filter 123.

LPC synthesis filter 123 sets the quantized LPC parameters outputted from LPC quantization section 122 as filter coefficients and generates synthesized signals using the outputs from adder 132 as the excitation.

Adder 124 subtracts the above-described synthesized signal from the input signal (i.e., modified input signal) of CELP encoding section 102 and calculates coding distortion. Perceptual weighting section 125 performs perceptual weighting for the coding distortion outputted from adder 124 using a perceptual weighting filter setting the LPC parameters outputted from LPC analyzing section 121 as filter coefficients. By performing closed-loop (feedback control) codebook search, distortion minimizing section 126 calculates indexes C_{A}, C_{D} and C_{G} to minimize coding distortion in adaptive codebook 127, fixed codebook 128 and gain codebook 129, respectively.

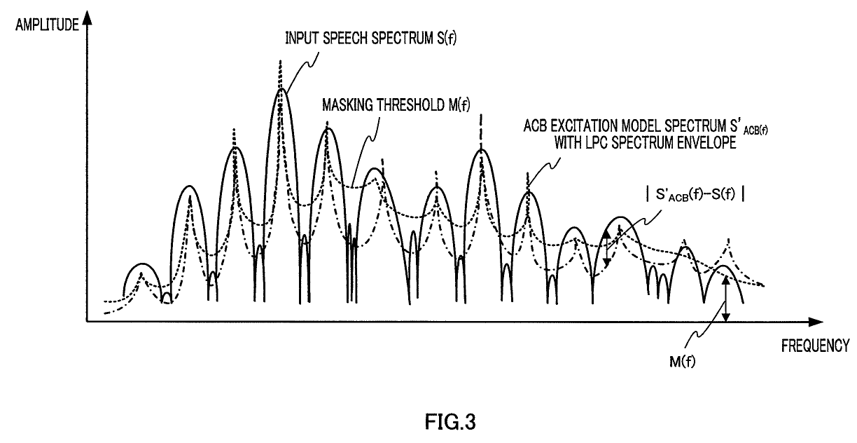

Next, the above-described modifying processing in input spectrum modifying processing 112 will be explained in detail with reference to FIGS. 3 to 5.

FIG. 3 is a pattern diagram showing the relationship between an input speech signal in the frequency domain, that is, the input speech spectrum S(f) and the masking threshold M(f). In this figure, the spectrum S(f) of input speech is shown by the solid line and the masking threshold M(f) is shown by the broken line. Further, the ACB excitation model spectrum S′_{ACB}(f) to which an LPC spectrum envelope shaping is performed, is shown by the dash-dot line.

Input spectrum modifying section 112 performs modifying processing on the spectrum S(f) of input speech with reference to both the masking threshold M(f) and the ACB excitation model spectrum S′_{ABC}(f) to which the LPC spectrum envelope shaping is performed.

In this modifying processing, the spectrum S(f) of input speech is modified such that the degree of similarity improves between the spectrum S(f) of input speech and the ACB excitation model spectrum S′_{ABC}(f). At this moment, the difference between the spectrum S(f) and the modified spectrum S′(f) is made less than the masking threshold M(f).

The above-described conditions and modifying processing are explained in detail using equations, the modified spectrum S′(f) is expressed as follows:

(Equation 2)

S′(f)=S′_{ACB}(f) [2]

(if, |S′_{ACB}(f)−S(f)|≦M(f))

(Equation 3)

S′(f)=S(f) [3]

(if, |S′_{ACB}(f)−S(f)|>M(f))

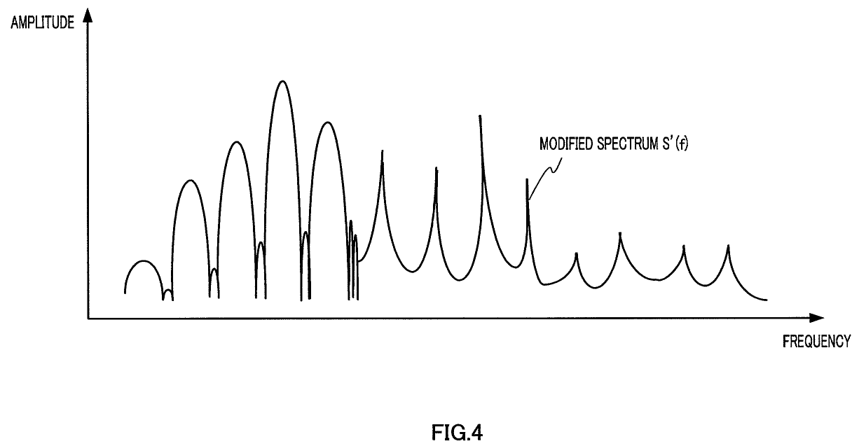

FIG. 4 illustrates the modified input speech spectrum S′(f) after the above-described modifying processing for the input speech spectrum shown in FIG. 3. According to FIG. 4, the above-described modifying processing extends the amplitude of the spectrum S(f) of input speech to match the S′_{ACB}(f), when the absolute value of the difference between the spectrum S(f) of input speech and the ACB excitation model spectrum S′_{ACB}(f), is equal to or less than the masking threshold M(f). On the other hand, when the absolute value of the difference between the spectrum S(f) of the input speech and the ACB excitation model spectrum S′_{ACB}(f) is greater than the masking threshold M(f), the masking effect may not be expected, and, consequently, the amplitude of the spectrum S(f) of input speech is kept as is.

As described above, according to the present embodiment, modifying processing adaptive to the speech model of CELP encoding is performed for input speech signals taking into consideration human auditory characteristics. To be more specific, the modifying processing includes calculating the masking thresholds based on the spectrum yielded by frequency domain conversion and calculating adaptive codebook model spectrums based on the adaptive codebook lag (pitch period) of the input speech signal. The input speech is then modified based on the value acquired by the above processing, and the inverse frequency domain conversion of the modified spectrum back to the time domain signal is performed. This time domain signal is the input signal for CELP encoding at the rear stage.

By this means, it is possible to improve the accuracy of encoding and the efficiency of encoding in CELP encoding. That is, it is possible to reduce coding bit rates and prevent quality degradation of reproduced speech signals.

According to the present embodiment, before CELP encoding, an adaptive codebook model spectrum is calculated from an input speech signal, and the spectrum of the input speech signal is compared to this spectrum, and the input speech signal is performed modifying processing in the frequency domain such that the input speech signal is adaptive to CELP encoding (in particular, adaptive codebook search) at the rear stage. Here, the spectrum after modifying processing is the input of CELP encoding.

By this means, modifying processing is performed on input speech signals in the frequency domain, so that resolution becomes higher than in the time domain and the accuracy of the modifying processing improves. Further, it is possible to perform modifying processing which is more adaptive to human auditory characteristics and more accurate than the order of the perceptual weighting filter, and improve the CELP encoding efficiency.

Further, in the above-described modifying processing, modifying is performed within a range auditory difference is not produced, taking into consideration the auditory masking thresholds acquired by input speech signals.

By this means, coding distortion after adaptive codebook search can be suppressed and more accurate encoding can be performed by the excitation of the fixed codebook, so that it is possible to improve encoding efficiency. That is, even if the above-described modifying processing is performed, quality of reproduced speech signals does not deteriorate.

Further, the above-described modifying processing is performed in speech signal modifying section 101 and is apart from CELP encoding, so that the configuration of an existing speech encoding apparatus employing the CELP scheme needs not to be changed and the modifying processing is easily provided.

Further, although a case has been described above with the present embodiment where the above equations 2 and 3 are used as an example of modifying processing on an input speech spectrum, the modifying processing may be performed according to the following equations 4 to 6.

(Equation 4)

S′(f)=S′_{ACB}(f) [4]

(if, |S′_{ACB}(f)−S(f)|≦M(f))

(Equation 5)

S′(f)=S(f)−M(f) [5]

(if, |S′_{ACB}(f)−S(f)|>M(f) and S(f)≧S_{ACB}(f))

(Equation 6)

S′(f)=S(f)+M(f) [6]

(if, |S′_{ACB}(f)−S(f)|>M(f) and S(f)<S_{ACB}(f))

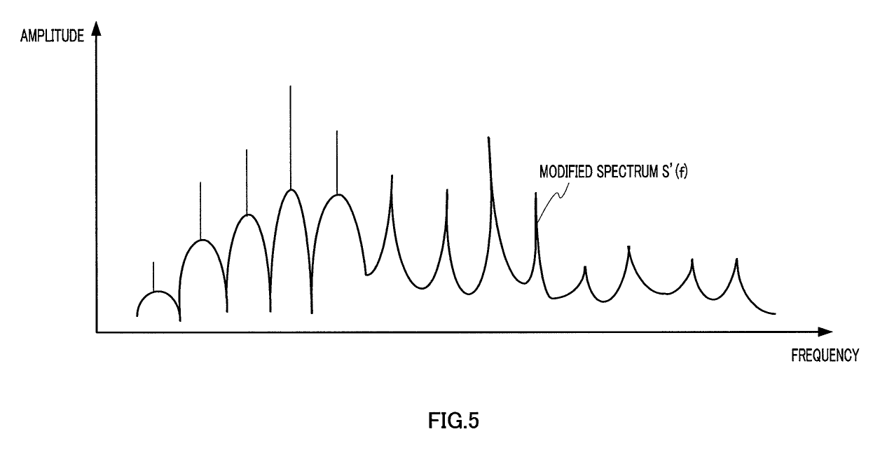

FIG. 5 illustrates the modified input speech spectrum S′(f) after the above-described modifying processing on the spectrum of input speech shown in FIG. 3. According to the processing of equation 3, when the absolute value of the difference between the spectrum S(f) of input speech and the ACB excitation model spectrum S′_{ABC}(f) to which an LPC spectrum envelope shaping is performed, is greater than the masking threshold M(f) and the masking effect is not expected, the spectrum S(f) of input speech is not modified. However, according to equations 5 and 6, as a result of adding masking thresholds to or subtracting the masking thresholds from the spectrum amplitude, the calculated value stays within a range of available masking effect, so that the input speech spectrum is modified within this range. By this means, it is possible to modify spectrum more accurately.

### Embodiment 2

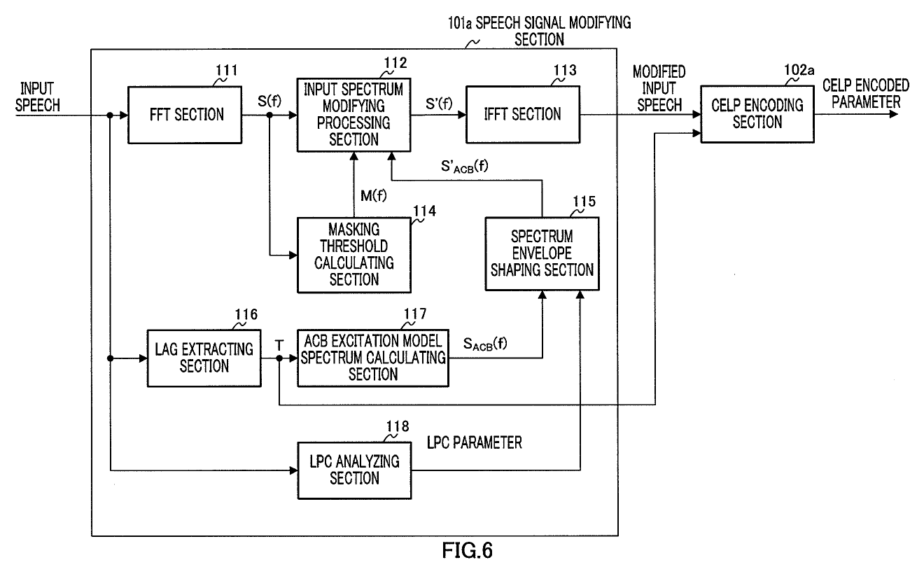

FIG. 6 is a block diagram showing main components of the speech encoding apparatus according to Embodiment 2 of the present invention. Here, the same components as in Embodiment 1 will be assigned the same reference numerals and detailed explanations thereof will be omitted.

In the speech encoding apparatus according to the present embodiment, the adaptive codebook lag T outputted from lag extracting section 116 is also outputted to CELP encoding section 102a. This codebook lag T is also used in encoding processing in CELP encoding section 102a. That is, CELP encoding section 102a does not perform processing of calculating the adaptive codebook lag T by itself.

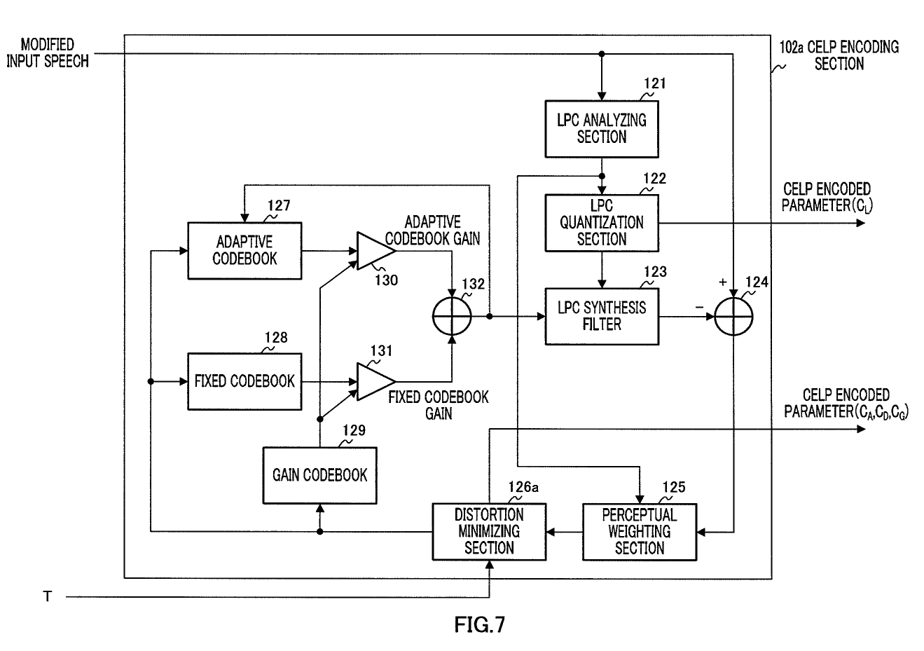

FIG. 7 is a block diagram showing main components inside CELP encoding section 102a. Here, the same components as in Embodiment 1 will be assigned the same reference numerals and detailed explanations thereof will be omitted.

In CELP encoding section 102a, the adaptive codebook lag T is inputted from speech signal modifying section 101a to distortion minimizing section 126a. Distortion minimizing section 126a generates excitation vectors for one subframe from the past excitations stored in adaptive codebook 127, based on this adaptive codebook lag T. Distortion minimizing section 126a does not calculate the adaptive codebook lag T by itself.

As described above, according to the present embodiment, the adaptive codebook lag T acquired in speech signal modifying section 101a is also used in encoding processing in CELP encoding section 102a. By this means, CELP encoding section 102a needs not to calculate the adaptive codebook lag T, so that it is possible to reduce the load in encoding processing.

Embodiments have been explained above.

The speech encoding apparatus and speech encoding method of the present invention are not limited to embodiments described above, and can be implemented with making several modifies in the speech encoding apparatus and speech encoding method. For example, although an input signal is a speech signal, the input signal may be signals of wider band including audio signals.

The speech encoding apparatus according to the present invention can be provided in a communication terminal apparatus and base station apparatus in a mobile communication system, so that it is possible to provide a communication terminal apparatus, base station apparatus and mobile communication system having the same interaction effect as above.

Although a case has been described with the above embodiments as an example where the present invention is implemented with hardware, the present invention can be implemented with software. For example, by describing the stereo encoding method and stereo decoding method algorithm according to the present invention in a programming language, storing this program in a memory and making the information processing section execute this program, it is possible to implement the same function as the stereo encoding apparatus and stereo decoding apparatus of the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The present application is based on Japanese Patent Application No. 2005-286531, filed on Sep. 30, 2005, the entire content of which is expressly incorporated by reference herein.

### INDUSTRIAL APPLICABILITY

The speech encoding apparatus and speech encoding method according to the present invention are applicable to, for example, communication terminal apparatus and base station apparatus in a mobile communication system.

1. A speech encoding apparatus comprising:
a encoding section that performs code excited linear prediction encoding for a speech signal; and
a preprocessing section that is provided at a front stage of the encoding section and that performs preprocessing on the speech signal in a frequency domain such that the speech signal is more adaptive to the code excited linear prediction encoding.

2. The speech encoding apparatus according to claim 1, wherein the preprocessing section comprises:
a converting section that performs a frequency domain conversion of the speech signal to calculate a spectrum of the speech signal;
a generating section that generates an adaptive codebook model spectrum based on the speech signal;
a modifying section that compares the spectrum of the speech signal to the adaptive codebook model spectrum, modifies the spectrum of the speech signal such that the spectrum of the speech signal is similar to the adaptive codebook model spectrum, and acquires a modified spectrum; and
an inverse converting section that performs an inverse frequency domain conversion of the modified spectrum back to a time domain signal.

3. The speech encoding apparatus according to claim 2, further comprising a calculating section that calculates a masking threshold in the spectrum of the speech signal,
wherein the modifying section modifies the spectrum of the speech signal within a range auditory difference is not produced based on the masking threshold, and acquires the modified spectrum.

4. The speech encoding apparatus according to claim 3, wherein, the modifying section makes the adaptive codebook model spectrum the modified spectrum when an absolute value of a difference between the spectrum of the speech signal and the adaptive codebook model spectrum is equal to or less than the masking threshold, and makes the spectrum of the speech signal the modified spectrum when the absolute value of the difference between the spectrum of the speech signal and the adaptive codebook model spectrum is greater than the masking threshold.

5. The speech encoding apparatus according to claim 3, wherein the modifying section makes the adaptive codebook model spectrum the modified spectrum when an absolute value of a difference between the spectrum of the speech signal and the adaptive codebook model spectrum is equal to or less than the masking threshold, makes a difference between the spectrum of the speech signal and the masking threshold the modified spectrum when the absolute value of the difference between the spectrum of the speech signal and the adaptive codebook model spectrum is greater than the masking threshold and the spectrum of the speech signal is equal to or greater than the adaptive codebook model spectrum, and makes a sum of the spectrum of the speech signal and the masking threshold the modified spectrum when the absolute value of the difference between the spectrum of the speech signal and the adaptive codebook model spectrum is greater than the masking threshold and the spectrum of the speech signal is less than the adaptive codebook model spectrum.

6. The speech encoding apparatus according to claim 2, further comprising:
an extracting section that extracts a pitch period from the speech signal; and
an analyzing section that performs linear prediction coefficients analysis for the speech signal to acquire a linear prediction coefficients parameter,
wherein the generating section generates the adaptive codebook model spectrum based on the pitch period and the linear prediction coefficients parameter.

7. The speech encoding apparatus according to claim 6, wherein the encoding section uses the pitch period extracted by the extracting section for the code excited linear prediction encoding.

8. A communication terminal apparatus comprising the speech encoding apparatus according to claim 1.

9. A base station apparatus comprising the speech encoding apparatus according to claim 1.

10. A speech encoding method comprising:
a encoding step of performing code excited linear prediction encoding for a speech signal; and
a preprocessing step of being provided at a front stage of the encoding step and performing preprocessing on the speech signal in a frequency domain such that the speech signal is more adaptive to the code excited linear prediction encoding.
